(19) United States
(12) Patent Application Publication
(10) Pub. No.: US 2022/0151383 A1
(43) Pub. Date: May 19, 2022

(54) MOUNTING DEVICE AND METHOD FOR SHELVES EQUIPPED WITH A LED STRIP

(71) Applicant: BORTOLUZZI SISTEMI S.P.A., Belluno (IT)

(72) Inventor: Bruno SPONGA, Belluno (IT)

(21) Appl. No.: 17/437,480

(22) PCT Filed: Mar. 8, 2020
(86) PCT No.: PCT/IB2020/051997

§ 371 Date: Sep. 9, 2021

(30) Foreign Application Priority Data
Mar. 12, 2019 (IT) 102019000003593

(51) Int. Cl. A47B 96/02

(52) U.S. Cl. CPC A47B 96/021; A47B 2220/0077

(57) ABSTRACT

A mounting device (30) is described for a first (12) and second (10) linear hollow frame segment that make up the frame of a shelf, wherein the frame is provided with a lighting LED strip (20). The device comprises a third portion (72) comprising a flat face (72) of dimensions corresponding to the width of the surface groove (22) so that it can be inserted into the surface groove and fill the portion of the surface groove closest to the angled surface of the first segment.

The invention relates to a mounting device and method for shelves, of furniture or shelving units, equipped with a LED strip.

It is known that furniture items or cabinets are provided with shelves that often have a built-in LED light strip. The LED strip is usually mounted superficially on the front segment of the shelf frame, in order to illuminate downwards and facilitate the user while rummaging inside the cabinet.

The LED strip is placed inside a linear seat obtained in the front segment, and extends along the length of the segment. The ends of the LED strip are cut at 45 degrees, to match the side segments of the frame, at their edge of mutual junction.

This type of assembly has several drawbacks.

First, the 45 degrees cut performed on the ends of the LED strip is a difficult operation, which requires precision. Even more difficult is the 45 degrees cut of the (usually metallic or plastic) section bar to create the seat for the LED strip. All these operations involve manufacturing errors, waste and man hours.

In addition, there is an electrical safety problem. The conducting cable that feeds the LED runs inside the section bars, and with small radii of curvature to reach the LEDs. There is the risk that the cable will peel on the sharp corners or burrs of the section bar, and then will short-circuit on the metal of the shelf.

Finally, it is very laborious to extract the LED strip from its seat, and a tool, a lot of strength and experience are needed. The wedging of the LED strip inside the interior corner of the section bar, as well as the matching at 45 degrees, makes extraction even more difficult.

Improving this state of the art is the main object of the invention, which is defined in the appended claims, in which the dependent ones define advantageous variants.

Another object is to provide an improved mounting device and method for shelves, of furniture items or shelving units, equipped with a LED strip.

Another object is to provide an improved shelf, of a furniture item or shelving unit, equipped with a LED strip.

The mounting device is for a first and second linear hollow frame segment which make up the frame of a shelf, wherein the frame is equipped with a lighting LED strip, and

wherein said two linear segments are

elongated along a respective longitudinal axis,

provided with an internal coaxial cavity, and

joinable at two complementary ends thereof along a respective, e.g. flat, surface angled by a first angle with respect to one of said longitudinal axes (e.g. at 45 degrees), so that the first and second linear segments are connectable forming a 90 degree angle, and

at least the first segment comprises a surface groove, in which the lighting LED strip can be installed in plain sight, which extends from said angled surface towards the center of the segment.

The mounting device comprises a flat face having dimensions corresponding to the width of the surface groove in order to be inserted snugly into the surface groove and fill the portion of the surface groove closest to the angled surface of the first segment.

Thanks to the mounting device, the LED strip can have rectangular plan, i.e. without angled or diagonal ends, and said flat face occupies the resulting empty space between one end of the LED strip and the joint edges of the two segments. Therefore the preparation and mounting operations of the aforementioned LED strip are greatly simplified.

In a preferred variant, optimal for integrating said flat face, the mounting device comprises a rigid body composed by

a first portion shaped and elongated along an axis so that it can be inserted coaxially into the internal cavity of the first linear segment in correspondence of the respective angled surface,

a second portion shaped and elongated along an axis so that it can be inserted coaxially into the internal cavity of the second linear segment in correspondence of the respective angled surface,

a third portion comprising the flat face.

In a preferred variant, the third portion comprises an abutment surface which is

angled with respect to the axis of the second portion by an angle equal to said first angle, and

is adapted to abut (preferably by matching) against the angled surface present at the end of the second linear segment.

The abutment surface is advantageous because it favors the coupling and the alignment between the mounting device and the second linear segment. In addition, the abutment surface simplifies the construction of the mounting device because it determines a pedestal for said flat face.

In a preferred variant, which simplifies the shape and production of the mounting device, the third portion is obtained integrally on/in the first portion.

In a preferred variant, which simplifies the shape and production of the mounting device, the second and/or third portion is obtained as a part protruding cantilevered from the first portion.

In a preferred variant, of structural simplicity and improved adaptation to linear segments with 45 degree ends (case in which said first angle is 45 degrees), said flat face is adjacent to the abutment surface; in particular said flat face and the abutment surface lie on two planes which form an angle greater than or equal to 90 degrees, in particular 120 degrees or 135 degrees.

In a preferred variant, said flat face lies on a plane which forms an angle between 30 and 60 degrees, in particular between 40 and 50 degrees, with respect to a plane parallel to the plane comprising said respective axes of the first and second portion.

In a preferred variant, said abutment surface lies on a plane which is

orthogonal to a plane comprising said respective axes of the first and second portion, and

inclined by 45 degrees with respect to each of said respective axes of the first and second portion.

This configuration improves the adaptation of the abutment surface to the ends of the linear segments.

In a preferred variant, said flat face consists of an area of triangular shape, wherein a first side of the triangle defines an edge between said flat face and the abutment surface. In particular said triangle is a right triangle, and said first side is its hypotenuse which defines an edge between said flat face and the abutment surface.

Preferably a second side of said triangle is parallel to the edge of the surface groove and/or to the axis of the second portion, to better stoop up said empty space.

Preferably a third side of said triangle is orthogonal to the longitudinal axis of the surface groove, to better stoop up said empty space.

The triangular shape of the flat face is well suited to stoop up the empty space in the surface groove between the end of the LED strip and the joint edges of the linear segments.

In a preferred variant, said flat face comprises an indentation along a side of the triangle, advantageous for inserting the tip of a screwdriver and removing the LED strip. In particular, the indentation is obtained on said third side of said triangle.

In particular, a preferred structure envisages that the assembly of the first and third portion form a shell that extends cantilevered from the rest of the device. Thus the first and third portion are thin, light and easily insertable into the relative linear segment.

In particular, for construction simplicity, the shell comprises three walls:

two walls that lie on imaginary planes having a straight line in common and being parallel to the axis of the first segment, the walls having an edge in common parallel to the axis of the first segment, and

a third wall which is adjacent to at least one of the other two and lies on a plane inclined with respect to said common straight line by an angle equal to said first angle, in such a way to be parallel to said angled surface.

In particular one of the two walls of the shell is constituted by said flat surface and the third wall is constituted by said abutment surface.

To facilitate the insertion of the first and/or second portion into the respective segment, preferably the first portion has a cross-section, considered on a section plane orthogonal to the axis of the portion, which is substantially constant.

To facilitate the insertion of the third portion into the mouth of the surface groove, preferably the third portion has a cross-section, considered on a section plane orthogonal to the axis of the first portion, which is substantially constant.

To facilitate the bending of an electric power-supply cable for the LED strip, preferably the first and third portions, or said shell, are fitted to the rest of the device via an open channel. In particular, the portion that connects the first and third portion, or said shell, to the rest of the device exhibits an edge which is rounded and/or with curved profile.

Another aspect of the invention is a first assembly method for a first and second hollow linear segment as defined above, wherein

a mounting device as defined above, in one or each variant, is inserted into the first and second segment.

Another aspect of the invention is a second assembly method for a first and second hollow linear segment as defined above, wherein

an element is inserted into the first and second segment, the element comprising a portion comprising a flat face of dimensions corresponding to the width of the surface groove in order to be inserted snugly into the surface groove and fill the portion of the surface groove closest to the angled surface of the first segment.

The first and second methods share the variants defined above for the mounting device.

The advantages of the invention will be even clearer from the following description of a preferred example of a system, referring to the attached drawing in which

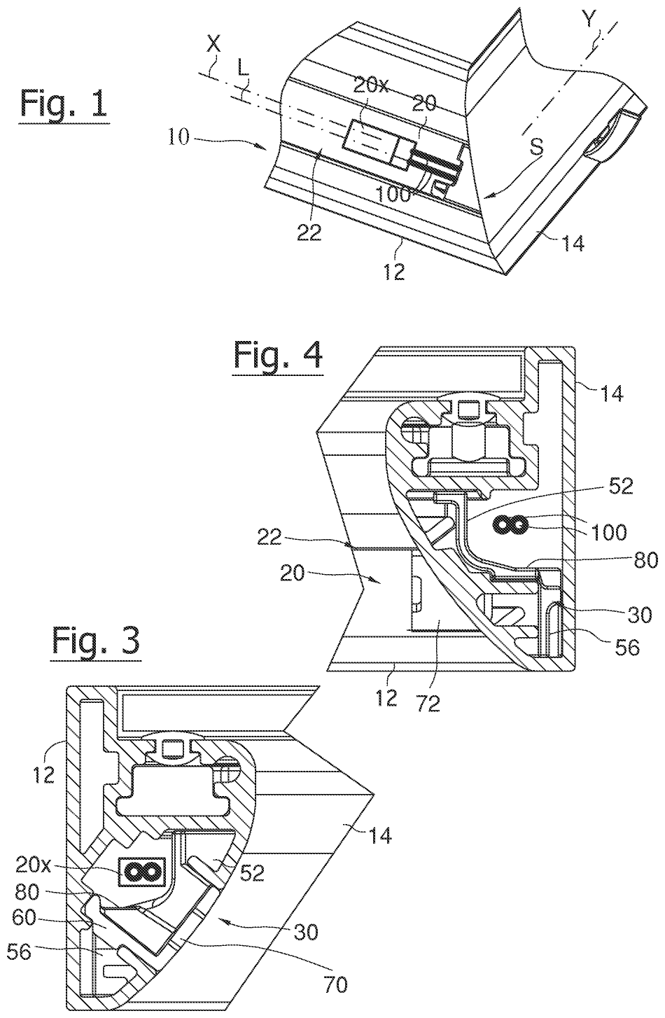

FIG. 1 shows a three-dimensional view of a front edge of a shelf for furniture or shelving unit;

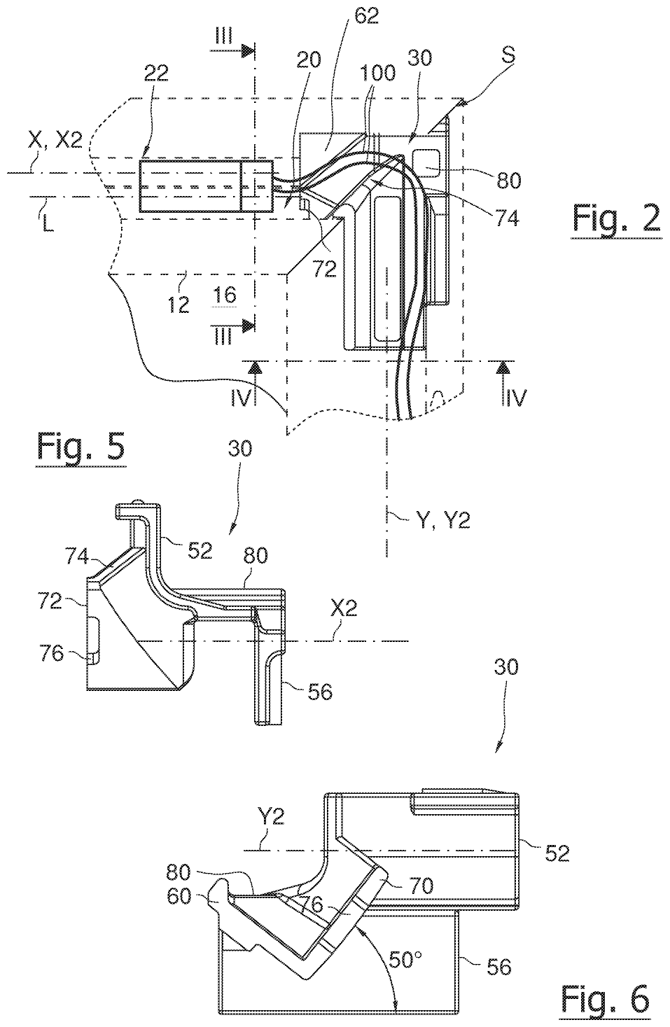

FIG. 2 shows a partial plan view of the edge of FIG. 1;

FIGS. 3-4 show vertical cross-section views according to plane III-III and IV-IV of FIG. 2, respectively, as well as an isolated component;

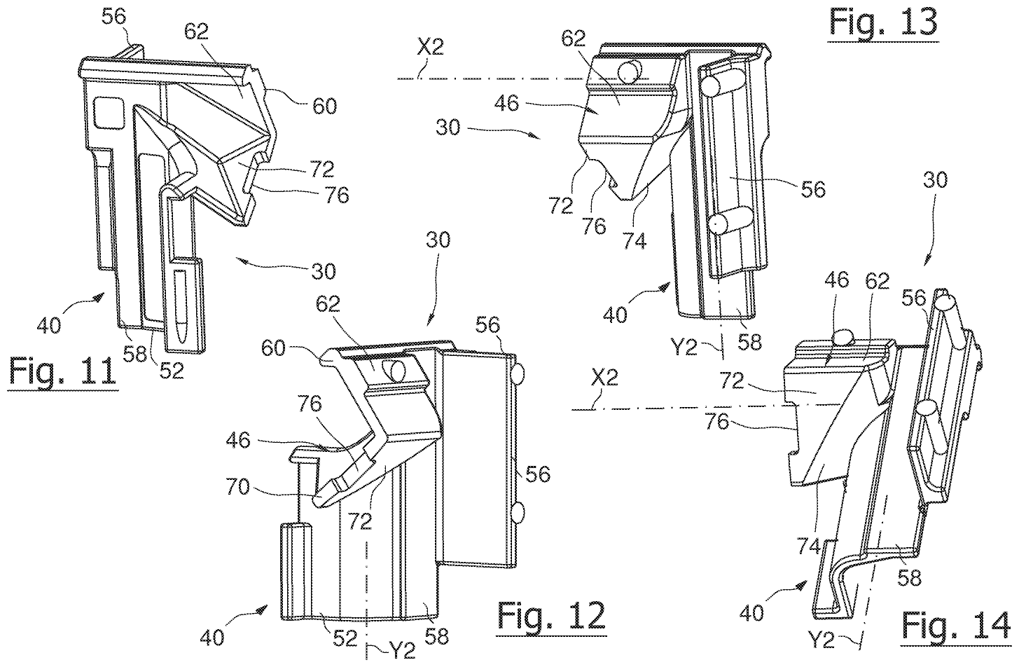

FIGS. 5-14 show three-dimensional views with different spatial orientations of a component of the shelf.

In the figures equal numbers indicate equal or conceptually similar parts, and the elements are described as in use. In order not to crowd the figures some numerical references are omitted.

FIG. 1 shows the edge of a shelf 10 comprising a frame formed by a front segment 12, a bottom segment (not shown) and two side segments 14. The segments 12, 14 are hollow tubular pieces, elongated along a respective axis X, Y, and with ends cut at 45 degrees relative to their axis to form angled surfaces S able to fit together (see FIGS. 1 and 2).

The segments 12, 14 can be assembled to form an overall rectangular or square frame. The object-supporting plane 16 of the shelf 10 lies—in use—on a horizontal plane.

The front segment 12 is provided with a seat or surface groove 22 inside which a LED strip 20 can be superficially installed. The power supply circuit of the LED strip 20 is indicated with 20X and the power cables with 100.

The LED strip 20 has the ends (FIGS. 1 and 2) ending with walls orthogonal to the longitudinal axis L of the LED strip 20.

The ends of the LED strip 20 are each joined to the end of the side segment 14 (the surface S) through a portion of a component 30 mounted partly inside the front segment 12 and partly inside the side segment 14 straddling the 45 degree junction between the segments 12, 14 (FIG. 2). That is, a portion of the component 30 stoops up the portion of the surface groove 22 which is closest to the surface S, connecting to the latter the end of the LED strip 20.

The component 30 is mounted in the shelf 10 in two specular specimens, one for each end of the strip 20 and for each angled conjunction between the segment 12 and the two side segments 14. For the sake of brevity we will describe the left component, here indicated in isolation with 30 and clearly visible in FIGS. 5 to 12.

The component 30 comprises two portions joined at an edge 90: a portion 40 that can be inserted coaxially inside the front segment 12 and a portion 46 coaxially insertable into the side segment 14.

The portion 40 extends along a Y2 axis and the portion 46 extends along a X2 axis. The Y2 axis and the X2 axis are parallel to the longitudinal X, Y axes of the segments 12, 14, respectively. Therefore the two portions 40, 46 extend along two directions orthogonal to each other (the Y2 axis and the X2 axis are orthogonal).

The portions 40, 46 are each a single piece, and are comprised in the component 30 as one piece. However, it is not necessary, although advantageous, that the component 30 or the portions 40, 46 are made of one piece.

The portion 40 is formed centrally by a flat surface 58 which extends longitudinally along the Y2 axis, from which a wall 52 extends orthogonally ending with an optional protruding tooth 54, parallel to the flat surface 58. From the latter there extends, on the opposite side with respect to the wall 52, a second wall 56, which ends up lying on a plane parallel to—and offset from—the wall 52. Preferably the wall 52 and the flat surface 58 are connected by a section 57 with curved cross-section.

The flat surface 58, along the Y2 axis and towards the corner 90, is wider than the base of the wall 52, so that the wall 52 ends before the flat surface 58 has reached the corner 90. It follows that at the corner 90 there is a free portion 80 of the flat surface 58 to which the portion 46 can be connected.

The portion 46 is defined in cross-section by two walls 60, 70 arranged like a V, wherein the vertex of the V forms an angle of 90 degrees. The walls 70, 60 lie on a plane orthogonal to the plane on which the walls 56 and 52 lie.

The wall 70 belongs to a flat face 72 of dimensions corresponding to the width of the surface groove 20 (see also FIG. 1) so as to fill the section of the groove 22 closest to the angled surface S of the segment 12.

The wall 60 belongs to a surface 62. The surface 62 and the flat face 72 lie substantially on planes orthogonal to each other.

The portion 46 comprises an optional abutment surface 74 which is angled with respect to the Y2 axis by an angle equal to the angle between the surface S and the X axis. Therefore the abutment surface 74 is adapted to abut against the angled surface S at the end of the segment 14.

The flat face 72 consists of an area in the shape of a right triangle, wherein a first side of the triangle defines an edge between the flat face 72 and the abutment surface 74. A second side of the triangle is parallel to the X2 and X axis.

In a preferred variant, the flat face comprises an indentation 76 along a side of the triangle.

The surface 62, the flat face 72 and the abutment surface 74 form a sort of a shell that is both insertable into the segment 12 and can rest against the angled end S of the segment 14.

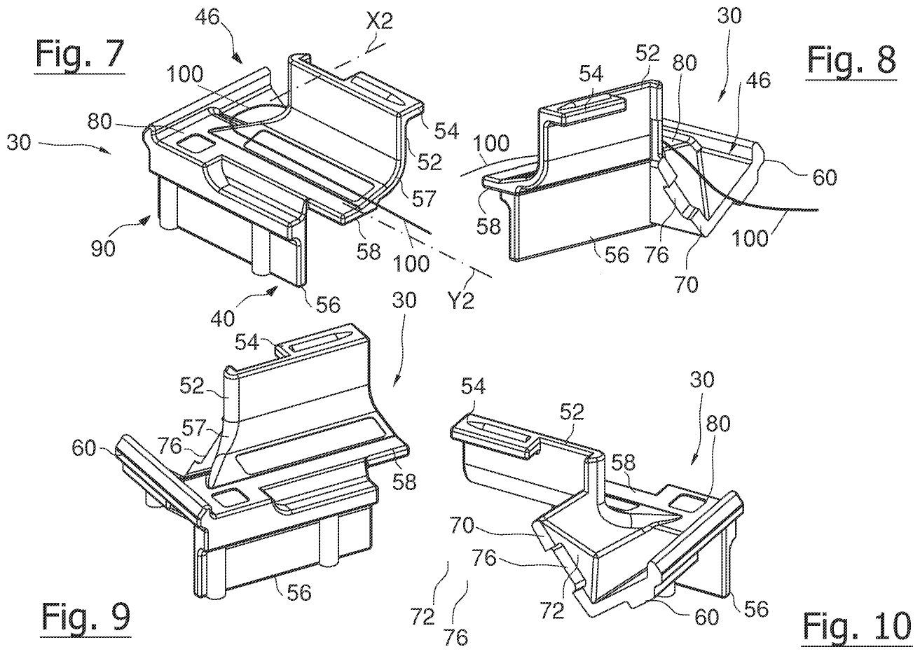

In FIGS. 7 and 8 an electric cable 100 is shown, to indicate how it is laid inside the component 30 to cross the segment 14 and supply the LED strip 20.

Note (e.g. see fig. 7) how the cable 100 is curved by 90 degrees without encountering cutting surfaces or too small curvature radii. In particular, the edge of the wall 52 and/or of section 57 is rounded and with a curved profile, to maximize the radius of curvature for the cable 100.

1. Mounting device for a first and second linear hollow frame segment that make up the frame of a shelf, wherein the frame is provided with a lighting LED strip, and
wherein said two linear segments are
elongated along a respective longitudinal axis,
equipped with an internal coaxial cavity, and
joinable at their two complementary ends along a respective surface angled by a first angle with respect to one of said longitudinal axes, so that the first and second linear segments can be connected forming a 90 degrees angle, and
at least the first segment comprises a surface groove, in which the lighting LED strip can be installed in plain sight, extending from said angled surface towards the center of the segment, wherein
the device comprises a flat face of dimensions corresponding to the width of the surface groove so that it can be inserted into the surface groove and fill the portion of the surface groove closest to the angled surface of the first segment.

2. Device according to claim 1, wherein the device comprises a rigid body composed of
a first portion shaped and elongated along an axis so as to be able to be inserted coaxially into the inner cavity of the first linear segment at the respective angled surface,
a second portion shaped and elongated along an axis so as to be able to be inserted coaxially into the inner cavity of the second linear segment at the respective angled surface,
a third portion comprising the flat face.

3. Device according to claim 2, wherein the third portion comprises an abutment surface which is
angled with respect to the axis of the second portion by an angle equal to said first angle, and
adapted to abut against the angled surface at the end of the second linear segment.

4. Device according to claim 2, wherein the third portion is integrally obtained on/in the first portion.

5. Device according to claim 2, wherein the second and/or third portion is formed as a part protruding cantilevered from the first portion.

6. Device according to claim 3,
wherein said flat face and the abutment surface lie on two planes which form an angle greater than or equal to 90 degrees, in particular 120 degrees or 135 degrees.

7. Device according to claims 3, wherein the abutment surface lies on a plane which is
orthogonal to a plane comprising said respective axes of the first and second portion, and
inclined by 45 degrees with respect to each of said respective axes of the first and second portion.

8. Device according to claim 3, wherein the flat face is constituted by a triangular-shaped area, wherein a first side of such triangle defines an edge between said flat face and the abutment surface.

9. Device according to claim 3, wherein the first and third portion form a shell which projects from the rest of the device.

10. Assembly method for a first and second hollow linear segment as defined in claim 1, wherein
an element is inserted into the first and second segment, the element comprising a portion comprising a flat, e.g. triangular, face of dimensions corresponding to the width of the surface groove so that it can be inserted into the surface groove and fill the portion of the surface groove closest to the angled surface of the first segment.
